(19) United States
(12) Patent Application Publication
(10) Pub. No.: US 2007/0079133 A1
(43) Pub. Date: Apr. 5, 2007

(54) Portable storage device having a subject identification information and a configuration method thereof

(76) Inventor: Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/490,045

(22) Filed: Jul. 21, 2006

(30) Foreign Application Priority Data
Oct. 4, 2005 (TW) 94134656

(51) Int. Cl. H04L 9/00; H04K 1/00; G06F 12/14; H04L 9/32; G06F 11/30

(52) U.S. Cl. 713/182; 713/193; 713/183; 713/184; 713/185

(57) ABSTRACT

A portable storage device having a subject identification information utilizes a user authentication module to update the subject identification information and displays the subject identification information. The portable storage device includes a control unit, a storage medium, a display unit, a system interface, and a user authentication module. The control unit includes an identification information display module and is used for processing the subject identification information. The storage medium utilizes the control unit to partition an identification information protection area that stores the subject identification information. The display unit is used to indicate the subject identification information. The system interface is used for connecting and linking with a host application system. The user authentication module is used for executing a user authentication process. After authenticated through the user authentication process, the user may than configure the information on the identification information protection area.

### BACKGROUND OF THE INVENTION

1. Field of the Invention

The present invention relates to a portable storage device that can display subject identification information to be identified by a user and a configuration method thereof. In particular, this invention relates to a portable storage device that can display a subject identification information and a configuration method for the subject identification information.

2. Description of the Related Art

In the information age requiring frequent data exchange, the portable storage device becomes very popular due to its' convenience for exchanging data and portability.

The conventional portable storage devices have been standardized by the manufacturer and are made by mass production for economic scale. Specific portable storage device purchased by an individual user may appears to be the same as or similar to others. In order to distinguish the portable storage device from others, user may intends to pastes a label or makes marking on the surface of the portable storage device.

Although volume label assigned to portable storage device can be indicated on its' host system, it can be easily modified by anyone using the host system. Hence, identification information assigned by owner is not properly protected and the indicated volume label can't be used reliably to identify specific user or utilization of the storage device.

### SUMMARY OF THE INVENTION

One particular aspect of the present invention is to display the specified application information of the portable storage device, such as owner's name, user's name, specific product utilization or certain graphical logo, etc. In addition, user authentication process is utilized to authenticate user before indicated information, including text and graphic, may be altered.

The present invention provides a portable storage device having a subject identification information. A user authentication module is utilized to verify user authorization and further the subject identification information is updated and displayed. The portable storage device includes a control unit, a storage medium, a display unit, a system interface, and a user authentication module. The control unit includes an identification information display module and is used for processing the subject identification information. The storage medium is connected with the control unit. The storage medium utilizes the control unit to partition an identification information protection area and the identification information protection area stores the subject identification information. The display unit is connected with the control unit and is used for displaying the subject identification information. The system interface is connected with the control unit and is used for linking with a host application system. The user authentication module is utilized to execute user authentication and authorization operation. Once authenticated, the user may then edit the subject information stored on the identification information protection area.

Thereby, subject information specified only by authorized user may be displayed and maintained on the portable storage device. Therefore, specific subject matter, such as owner, user, or application of the portable storage device may be identified easily by the indicated subject information that is protected and may be setup or changed only by authorized personnel. And hence, device property and usage right may be ensured.

Indicating subject information in conventional means, such as pasting a label or changing disk volume label, is insecure for indicated information may be easily removed or modified. Conversely, the present invention may protect indicated subject information by ensuring only authorized user may setup or configure the information to be displayed and hence the correctness of such information.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of a first embodiment of the present invention;

FIG. 2 is a block diagram of a second embodiment of the present invention; and

FIG. 3 is a flow chart of a configuration method for a portable storage device with a subject identification information of the present invention.

### DETAILED DESCRIPTION OF THE PREFERRED EMBODIMENTS

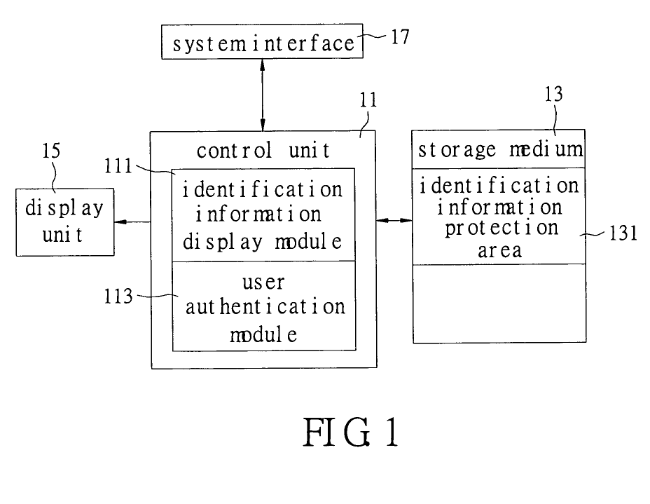

Please refer to FIG. 1, which shows a block diagram of a first embodiment of the present invention. In a control unit 11 there are an identification information display module 111 and a user authentication module 113. The control unit 11 is connected with a storage medium 13, a display unit 15 and a system interface 17. An identification information protection area 131 is partitioned from the storage medium 13 by the control unit 11. The identification information protection area 131 is used for storing the subject identification information and the security authentication information. The subject identification information is a data, including text, string and/or certain graphical logo that may be used to identify ownership or other subject information of the device. The identification information display module 111 displays the subject identification information on the display unit 15. The display unit 15 is a bistable display device, or there is an independent power located in the portable storage device for providing the power to the display unit 15. Thereby, the subject identification information can be displayed on the display unit 15 at any time. The system interface 17 is connected and linked to a host application system for transmitting the data. The host application system may be a computer or a device that require read/write access to the portable storage device.

The user authentication module 113 is used to identify the operating user and utilizes a user authentication process to authenticate if the user is authorized. After the user is authenticated by the user authentication process, the authorized user may then modifies the subject identification information and the security authentication information in the identification information protection area 131. The security authentication information is a database provided for the user verification module 113 to authenticate user authorization. In other words, whether the user verification module 113 authenticates the user, by using password, issued identification token or biometric identification, the outputted identification data is verified with the security authentication information in the storage device. The result of the verification determines whether the user is authorized or not. The security authorization information is located in the identification information protection area 131 and can be modified only after the user passes the user authentication process.

In this embodiment, the user authentication module 113 is a fingerprint verification module. The portable storage device reads a subject identification information located on the identification information protection area 131 via the identification information display module 111 and displays the subject identification information on the display unit 15. For example, the subject identification information is “a portable disk of a R&D division”, “Jason's memory”, “#1234” and/or images. If someone wishes to modify the subject identification information indicated on the display unit, the user has to be authenticated by the fingerprint verification module on the portable storage device. After the user passes the user authentication process, the user may then change the subject identification information indicated on the display unit 15.

After the fingerprint verification module identifies the biometric identification of the user's fingerprint, the fingerprint verification module outputs an identified data. Then, the identified data is verified with the security authentication information configured by the owner in the identification information protection area 131. If the identified data matches with the security authentication information, the user is authenticated by the fingerprint verification module as an authorized user. The authorized user is allowed to setup or modify the security authentication information and the subject identification information. If the verification result is miss-match, the user is not authorized by the fingerprint verification module to modify the security authentication information and the subject identification information in the identification information protection area 131. Therefore, the subject identification information configured by authorized personnel is retained and the indication on the display unit 15 remained unchanged.

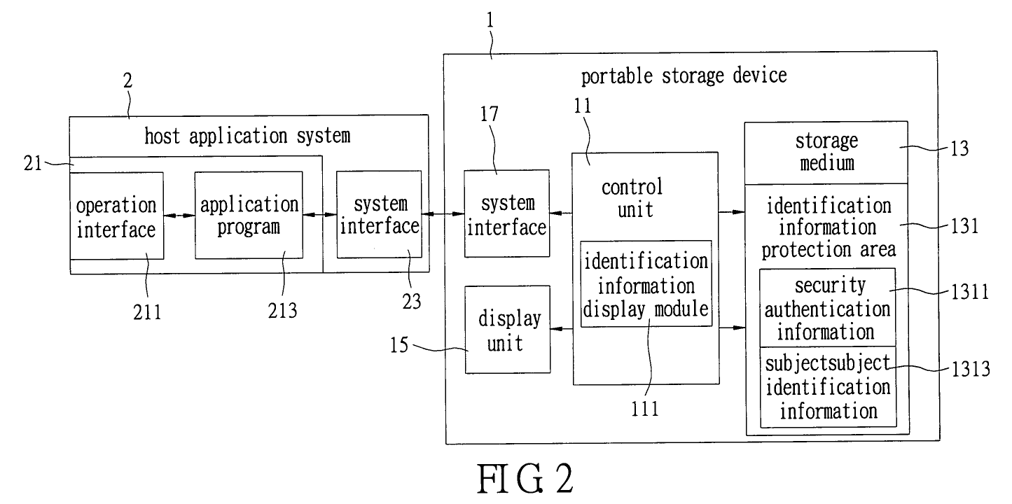

Please refer to FIG. 2, which shows a block diagram of a second embodiment of the present invention. The figure shows a block diagram of the portable storage device 1 connected and linked with a host application system 2 via the system interface 17 and 23. The user authentication module 21 of the host application system 2 is implemented by an operation interface 211 and an application program 213. The user enters a verification signal via the operation interface 211 and the application program 213 obtains a security authentication information 1311 in the portable storage device via the system interface 17 and 23. The verification signal entered by the user is verified with the security authentication information 1311 to determine whether the user is the authorized or not. The security authentication information 1311 is configured by authorized personnel and is stored in the identification information protection area 131. The identification information protection area 131 is located in the storage medium 13 and is partitioned by the control unit 11. The identification information protection area 131 further comprises a subject identification information 1313. The subject identification information 1313 may be text, string and/or graphical logo that may be used to identify ownership or other subject information of the device. The identification information display module 111 displays the subject identification information 1313 on the display unit 15. The display unit 15 is a bistable display device, or there is an independent power located at the portable storage device 1 for providing the power to the display unit 15. Thereby, the subject identification information 1313 can be displayed on the display unit 15 at any time.

The user verification module 21 on the host application system 2 executes a user verification process to authenticate the user by using password, issued identification token or biometric identification. The user authentication process is executed by the application program.

In this embodiment, the application system 2 utilizes the user authentication module 21 with password authentication. The portable storage device 1 reads a subject identification information 1313 located on the identification information protection area 131 via the identification information display module 111 and displays the subject identification information 1313 on the display unit 15. For example, the subject identification information 1313 displayed on the display unit 15 is “a portable disk of a R&D division”, “Jason's memory”, “#1234” and/or images. If someone wishes to modify the subject identification information 1313, the user has to connects the portable storage device 1 to the host application system via the system interface 17 and 23 and the user verification module 21 on the host application system 2 is a password authentication module and is implemented by an operation interface 211 and an application program 213. The operation interface 211 is a character input device (such as keyboard). The application program 213 executes a user authentication process.

After the user inputs a password via the operation interface 211, the application program 213 reads the security authentication information 1311 in the identification information protection area 131 of the portable storage device 1. Then, the security authentication information 1311 is verified with the user entered password to determine whether the user is authorized. If entered password is authenticated, the user is then authorized to modify the subject identification information 1313 and reset the safety verification information 1311. The verified user can set or change the safety identification information and the subject identification information. If the verification code is wrong, the user is not verified by the user verification process, the user is not allowed to modify the subject identification information 1313 displayed on the display unit 15.

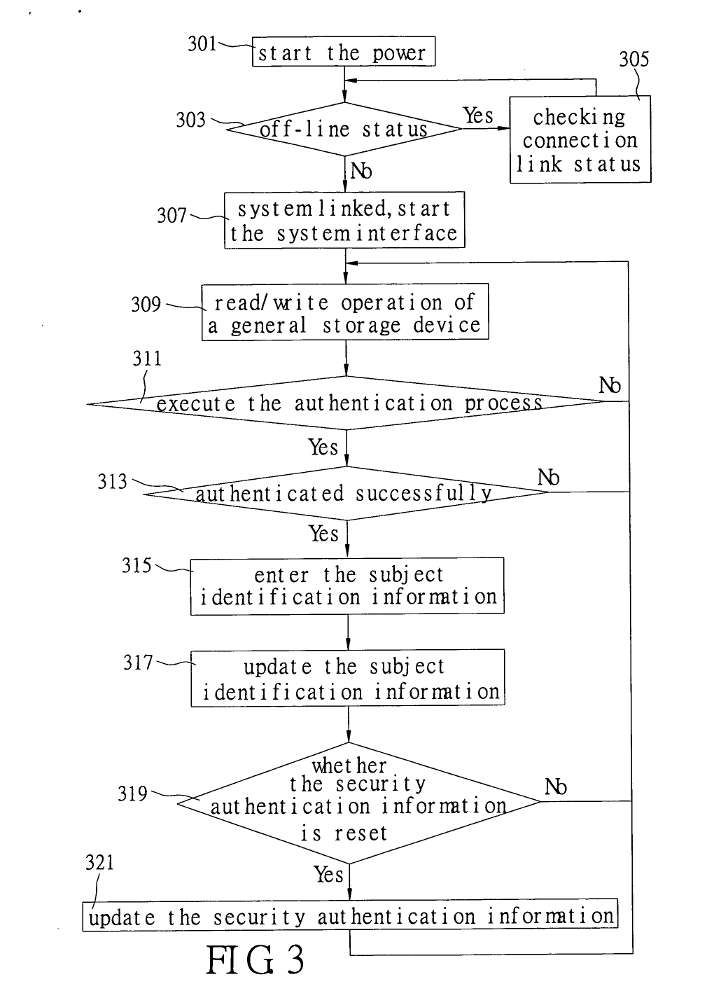

Please refer to FIG. 3, which shows a flow chart of a configuration method for a portable storage device with a subject identification information of the present invention. Firstly, the power of the portable storage device is turned on and at the mean time a subject identification information is displayed on the display unit (the step S301 as shown in the figure). Then, connection status of the portable storage device is checked (S303). If the portable storage device is on off-line status, connection status is repeatedly checked (S305). If portable storage device is on on-line status, the system interface is started to execute a linking process (S307). After the portable storage device is linked with the system, the portable storage device is ready to execute read/write operations as a general storage device (S309). If the user wishes to modify or reconfigure the subject identification information, the security authentication information or others, the method judges whether the user authentication process is required (S311). If the user authentication process is not required, the method returns to the step S309 and executes a read/write operation as a general storage device. If the user wishes to modify or reconfigure the subject identification information and the security authentication information while the user verification process is required, the portable storage device verify the security authentication information located on the identification information protection area with the authentication information entered by the user and processed by the user authentication module to determine whether the user passes the user authentication process (S313). If the verification result is miss-match, the user not authorized and the process return to the step S309 to execute read/write operations as a general storage device. If the verification result is match, the user is authorized to enter new subject identification information (S315). The display module updates the subject identification information in the identification information protection area and displays the subject identification information on the display unit according to the subject identification information entered at step S315 (S317). Moreover, the method judges whether the security authentication information needs to be reconfigured or not (S319). If the security authentication information does not need to be reconfigured, the method returns to the step S309 to execute read/write operations as a general storage device. If the security authentication information needs to be reconfigured, the control unit on the portable storage device utilizes the user authentication module to obtain the new subject identification information and update the subject identification information in the identification information protection area (S321). After the subject identification information is updated, the method returns to the step S309 to execute read/write operations as a general storage device.

The above user authentication module may be installed in the host application system. The user authentication process is implemented by the user operation interface and the application program and is executed in the host application system. Alternatively, the user verification module may be configured in the portable storage device and the user authentication is executed in the portable storage device. After the user is authenticated, the subject identification information displayed on the display unit may be modified. Thereby, correctness of the indicated subject identification information is ensured. Therefore, the righteous subject or user may be easily identified by the indicated subject identification information.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable storage device having a subject identification information, comprising:
a control unit, having an identification information display module for processing the subject identification information;
at least one storage medium, connected with the control unit, wherein an identification information protection area to store the subject identification information is partitioned;
a display unit, connected with the control unit and used for displaying the subject identification information;
a system interface, connected with the control unit and used for linking with an host application system; and
an user authentication module, used for executing a user authentication process, wherein after the users' authorization is verified through the user authentication process, the user may configures the information on the identification information protection area.

2. The portable storage device having a subject identification information as claimed in claim 1, wherein the user verification module is configured within the control unit.

3. The portable storage device having a subject identification information as claimed in claim 1, wherein the identification information protection area further comprises a security authentication information for providing to the user verification module to execute the user authentication process.

4. The portable storage device having a subject identification information as claimed in claim 1, wherein the user authentication module is a fingerprint identification module, a password verification module and/or an identification token verification module.

5. The portable storage device having a subject identification information as claimed in claim 1, wherein the user authentication module is configured in the host application system.

6. The portable storage device having a subject identification information as claimed in claim 5, wherein the host application system executes the user authentication process via an application program.

7. The portable storage device having a subject identification information as claimed in claim 5, wherein the identification information protection area further comprises a security authentication information for providing to the user authentication module to execute the user authentication process.

8. The portable storage device having a subject identification information as claimed in claim 5, wherein the user authentication module is a fingerprint identification module, a password verification module and/or a identification token verification module.

9. The portable storage device having a subject identification information as claimed in claim 1, wherein the subject identification information is a text, a string data and/or a graphical logo.

10. The portable storage device having a subject identification information as claimed in claim 1, wherein the display unit is a bistable display device.

11. The portable storage device having a subject identification information as claimed in claim 1, further comprising an independent power unit for providing the power to the display unit.

12. A configuration method for a portable storage device with a subject identification information, the subject identification information is configured via the user authentication process, the steps comprising:
executing the user authentication process by a user authentication module;
determining whether the user is authorized or not;
configuring the subject identification information after the user is authenticated; and
updating the subject identification information after the subject identification information is reconfigured.

13. The configuration method for a portable storage device with a subject identification information as claimed in claim 12, wherein the user authentication module executes the user authentication process by password verification, issued identification token verification and/or biometric identification.

14. The configuration method for a portable storage device with a subject identification information as claimed in claim 12, wherein the user authentication module generates a identification data, and the identification data is verified with a security authentication information to determine whether the user is authenticated by the user authentication process.

15. The configuration method for a portable storage device with a subject identification information as claimed in claim 14, wherein the security authentication information is stored at an identification information protection area of the portable storage device.

16. The configuration method for a portable storage device with a subject identification information as claimed in claim 14, wherein after authenticated by the user authentication process, the user may then reconfigure the security authentication information.

17. The configuration method for a portable storage device with a subject identification information as claimed in claim 12, wherein the subject identification information is stored at an identification information protection area of the portable storage device.

18. The configuration method for a portable storage device with a subject identification information as claimed in claim 12, wherein the user authentication process is implemented by connecting the portable storage device with a host application system and executed by an application program of the host application system.

19. The configuration method for a portable storage device with a subject identification information as claimed in claim 18, wherein the application program obtains a security authentication information at an identification information protection area to determine whether the user is to be authenticated.

20. The configuration method for a portable storage device with a subject identification information as claimed in claim 19, wherein after authenticated by the user authentication process, the user may then reconfigure the security authentication information.

21. The configuration method for a portable storage device with a subject identification information as claimed in claim 12, wherein the user authentication module is configured at the portable storage device.

22. The configuration method for a portable storage device with a subject identification information as claimed in claim 12, wherein the subject identification information is displayed at a display device of the portable storage device.
